(19) United States
(12) Patent Application Publication
(10) Pub. No.: US 2021/0294980 A1
(43) Pub. Date: Sep. 23, 2021

(54) Knowledge Based-Operating System

(71) Applicant: Kevin J. Dowd, Niantic, CT (US)

(72) Inventor: Kevin J. Dowd, Niantic, CT (US)

(73) Assignee: Kevin J. Dowd, Niantic, CT (US)

(21) Appl. No.: 17/249,926

(22) Filed: Mar. 18, 2021

Related U.S. Application Data
(60) Provisional application No. 62/992,008, filed on Mar. 19, 2020.

(51) Int. Cl. G06F 40/30; G06N 5/02; G06N 5/04; G06F 8/41

(52) U.S. Cl. CPC G06F 40/30; G06F 8/41; G06N 5/04; G06N 5/02

(57) ABSTRACT

System and methods for the extraction of knowledge from human language for computation, storage, retrieval, transmission, communication with robotics and sensors and conversion back to human language for the purpose of interfacing with humans and other natural language environments.

### RELATED APPLICATION

The present application claims the benefit of U.S. Provisional Patent Application No. 62/992,008, filed Mar. 19, 2020, the disclosure of which is hereby incorporated by reference.

### BACKGROUND OF THE INVENTION

Natural language processing (NLP) systems are computer-implemented methods for taking natural language input and operating on the input so as to generate output that is useful for computers to derive meaning. Examples of NLP systems applications include spell checkers/grammar checkers, machine translation systems, and speech-to-text systems. Increasingly, there is interest in developing methods for machines to intelligently interpret human language input data for the purpose of directing the computer as if it were another person who could understand speech. Examples of systems, methods, and devices developed in the field of NLP are Dowd, Natural Language Processing, Notes, 1996-2010; U.S. Pat. Nos. 10,572,801; 9,336,306; 10,572,540; 10,528,665; 10,572,684; 10,565,189; 9,098,492; 9,348,815; 9,542,447; 10,262,261; 10,325,205; 10,565,291; 10,572,810; 10,445,656; 10,445,655; 10,445,648; 10,325,207; and, 10,460,034, each of which is hereby incorporated herein by reference.

### SUMMARY OF THE INVENTION

The invention relates to a knowledge operating system (KOS) programmed in human language comprising: a token recognition module (TCM) configured to collect a plurality of vocabulary elements and combine the vocabulary elements into a plurality of data structures (DS); a plurality of explicit and implicit inference modules (IM) configured to process the data structures into a plurality of knowledge based complex concepts (CCs); a memory module (MM) configured to read, collect, store, index, group, and transform CCs into a plurality of memory processed complex concepts (MCC); a plurality of communication modules (CM) configured to store, retrieve, and share results obtained from the MCCs between one or more additional systems programmed in human language, processes and backing stores; a plurality of output modules (OM) configured to sort MCCs through an election process in order to arrive at a single interpretation of the vocabulary elements; and, one or more natural language output modules configured to share the single interpretation with one or more endpoints, such as a user, a differing process, a differing processor, and the like.

The invention further relates to a method comprising the steps of: (a) communicating with an artificial intelligence (AI) through presentation of one or more classification vectors from a knowledge operating system (KOS); (b) utilizing the AI to interpret the one or more classification vectors as new input data or old input data; (c) creating a new classification vector based on the interpretation in step (b); (d) returning the new classification vector to the KOS; (e) sorting the new classification vector through an election process in order to arrive at a single interpretation of the one or more classification vectors.

The invention further relates to a method of problem solving by means of a human language-based knowledge representation system (KR), the method comprises the steps of: (a) establishing an index of memories within the KR; (b) building forward memory paths and reverse memory paths by means of a plurality of memory segments; (c) indexing and storing the memory segments; (d) inputting an initial condition starting point; (e) identifying the stored memory segments of step (c) that contain conditions similar to the step (d) starting point; and, (f) outputting the final condition end point by means of one or more output modules.

The invention further relates to a method of problem solving by means of a human language-based knowledge representation system (KR), the method comprises the steps of: (a) establishing an index of memories within the KR; (b) building forward and reverse memory paths by means of a plurality of memory segments, wherein the memory segments comprise a plurality of the step (a) CCs connected in a chronological linear path and each memory segment comprises a first portion head, a middle portion, and a last portion tail; (c) indexing and storing the memory segments, wherein each of the head portion and the tail portion of each memory segment may be indexed together or separately; (d) inputting an initial condition starting point; (e) identifying the stored memory segment of step (c) that contains conditions similar to the step (d) starting point; (f) translating the identified stored memory segment of step (e) into natural language; (g) generating the natural language of step (f) into a final condition end point; and, (h) outputting the final condition end point by means of one or more natural language output modules.

### BRIEF DESCRIPTION OF THE DRAWINGS

FIG. 1 depicts an example of a knowledge operating system (KOS).

FIG. 2 depicts an example of the hierarchal vocabulary of the system.

FIG. 3 depicts an example of a system speech tag data structure.

FIGS. 4a, 4b, 4c, 4d, and 4e depict parent and child data structures.

FIG. 5 depicts an individual data structure associated with tag values.

FIG. 6 depicts a memory as a running context of three data structures.

FIGS. 7a, 7b, 8a, 8b, 8c, and 8d depict examples of data structures interpreting simple English input.

FIG. 9 depicts an example of child/parent data structures influenced by grammar rules.

FIG. 10 depicts an example of a data structure interpreting simple English input.

FIGS. 11a and 11b depict examples of child/parent data structures influenced by hashing mechanisms.

FIGS. 12-15 depict examples of classification vectors.

FIG. 16 depicts an example of a memory segment with a plurality of data structures.

FIG. 17 depicts an example of memory segments coupled and overlapped.

FIG. 18 depicts a simple directed graph indicting node paths that may lead to the shortest path to the discovery end point.

### DETAILED DESCRIPTION

Described herein is a system or a program that can understand language, maintain context, remember, capture knowledge, and answer questions. The system is computation with knowledge. Its primitives are natural language propositions (facts) and inference templates (executables), plus dynamically generated knowledge, executables, and context. Taken together, knowledge and context motivate goal-oriented computation, conversation, and action. The captured knowledge is represented by trees, similar to sentence diagrams. These can be manipulated, stored, recalled, and generalized as processing proceeds. Once the tree is created, the words are no longer needed. The tree structure stands for captured knowledge in the absence of language.

The predictive system can parse and interpret simple English. Both the vocabulary and language grammar are known to the program in advance. User inputs (>>) are visible, followed by system responses. The first few statements are inference templates. A chain of inferences are then exercised by providing a proposition, such as “luigi is near the princess.” At the end of the code sample, the system answers “why?” to reveal the nature of its conclusions.

This invention relates to a system that is a programming environment and knowledge-based operating system (KOS) that can bring programs to life, such as a dog program that will build a functioning simulated dog. A knowledge operating system (KOS) may be defined as an active clearinghouse for knowledge-based events, computation, and translation between natural language and data. The KOS may be an operating system that is continually processing and/or waiting for input events.

For example, how would you program a dog? How would a person model a dog, such as the things it does, its goals? If the person is a programmer, they may approach the problem by thinking of the dog as a collection of systems, such as the tail, the paws, a growl, and the role of those systems in a dog's many possible states, such as happy, sad, angry. A programmer might describe what they know about dogs and leave it at that. For the purpose of modeling a dog, knowledge about dogs may be sufficient. However the programming is approached differently. If a person can describe a dog, such as, the way it reacts to its world and responds to its own desires, and write that description down, then a person can program a dog.

A dog program may be written as:

You sleep in the sun.
You hear the mailman.
You bark.
You run to the door.
You scratch the door.
You see the mailman.
Mail falls on the floor.
You bite the mail.
The above language is simple. There is one idea per line. The ideas are in sequence. After many such lines, the nature of a dog becomes clearer, i.e. a person comes to know when the dog will bark, where it likes to sleep and what excites it. The model captures the essence of a dog by virtue of the dog's experiences. It is the brain of the dog.

In order for the dog's brain to be in motion, stimulus must be provided. The stimuli comes from interfaces to the outside world. These stimuli will allow the dog to see and hear, and will drive animation. When the eyes report a squirrel, the brain can tell the legs to run. The interfaces must be asynchronous so that a real-world action, such as a dog running to its food dish, can be given time to complete while other actions take place. Interfaces must support overlap and preemption. The overlap and preemption will allow the dog to see, bark, run, wag its tail all at once, like a dog.

A person may want to train the dog. Perhaps the training will focus on finding slippers, watching for burglars or to locate Timmy in the well. Requests such as training a dog require a scripting mechanism that can direct the system toward specific goals, such as knowledge-seeking, slipper-finding or Timmy-locating. Many kinds of goal-seeking behavior could run concurrently satisfying multiple distinct and simultaneous goals.

The dog program begins by creating memories for the dog. Starting with basic memories and/or first memories, such as the experience of sunshine or rain. More complex memories and/or secondary, tertiary, etc. memories, about birds or an encounter with a cat may follow. More complicated memories about being hungry or finding food may be continually built upon the first, second, third, etc. memories. The memories are stored as simple English and are complied into binary form.

During the memory compilation process, a check of the information input is performed. During the check, an initial discovery that additional vocabulary may be needed or that a particular input wasn't interpreted as expected, leads to an iterative process of memory-building. A memory is read into the system, the result is inspected, and depending on the result, changes to the text, the vocabulary, or modifications to the input grammars may be needed. When the result is acceptable, the memories can be compiled into binary form. Once in binary form, memories are ready for runtime use by the program.

Why program in English or any human language? Human language captures knowledge and makes knowledge portable. Programming the system with English is programming with knowledge. This is very different than computing with data, which is the familiar programing course of programmers. Knowledge-based computation is data-driven, rather than procedural. The relationships between the data elements are established by the data themselves.

To highlight the differences between programming with knowledge and computing with data, the phrase “I love you” is programmed differently utilizing knowledge than in C, Perl or JavaScript. For example, utilizing knowledge-based computation the statement “I love you” will be parsed, stored, and indexed. The parsel, storage, and indexing may cause changes in pre-existing stored knowledge, the exercise of implicit and explicit inferences, the recall of memories and some interprocess communication. Love might even be requited.

Next, scripts may be added, which are called Motives in the system. Motives provide a way for the user to direct processing toward specific goals. In the case of the dog, the user might script being hungry and finding something to eat. On top of that, the user might overlay guidance for how to bite the mailman. As with memories, building motives is an iterative process. One creates a flow chart with conditions, branches and results, and casts it into code. Then test, revise, and test, etc. At runtime, motives operate in conjunction with memories.

Input drives computation and communication with the world. Text or knowledge-based interfaces to outside processes may be constructed. These might include sensors or robots, language-based data feeds or other copies of the system, all of which are trading knowledge. The user tells the system where to find the robots, sensors and peers on the network. A channel may also be left open for user text input. Using input, computation, and communication external events can be simulated and watched.

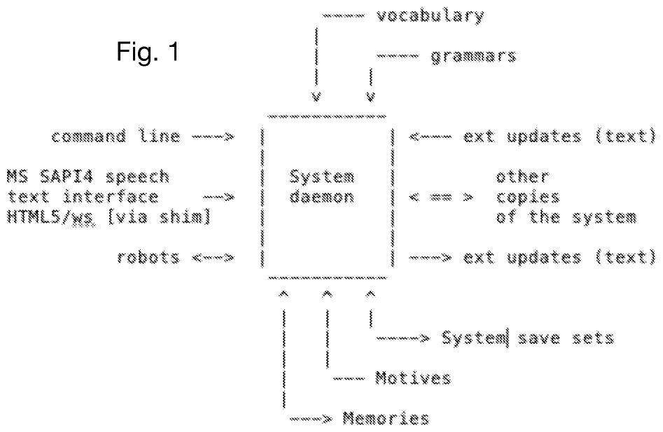

The system or the program runs as a stand-alone application or as a network daemon. It can listen on many interfaces at once. Though most of the programming is in English, much of its computation contains no language at all. FIG. 1 depicts an example of a knowledge operating system (KOS).

Programs and models built with the system can be useful in video games, intelligent weaponry, as user agents and in behavior prediction. As indicated, the knowledge found in disparate narratives can combine to create new observations under novel conditions. As a result, the system can show the spark of intuition.

The following sections provide insight into some of the practical considerations for programming the system and model building.

### Vocabulary

To read human language, the system has to recognize the tokens (words) and it has to make sense of their order. Tokens and order are prescribed by a vocabulary and a grammar. The vocabulary says what the tokens can be. The grammar says how they can be combined. The vocabulary and grammar create the possibilities for, and define the limits of, what the system can understand. Vocabulary elements may be collected and combined into a plurality of complex concepts via or by means of token recognition modules.

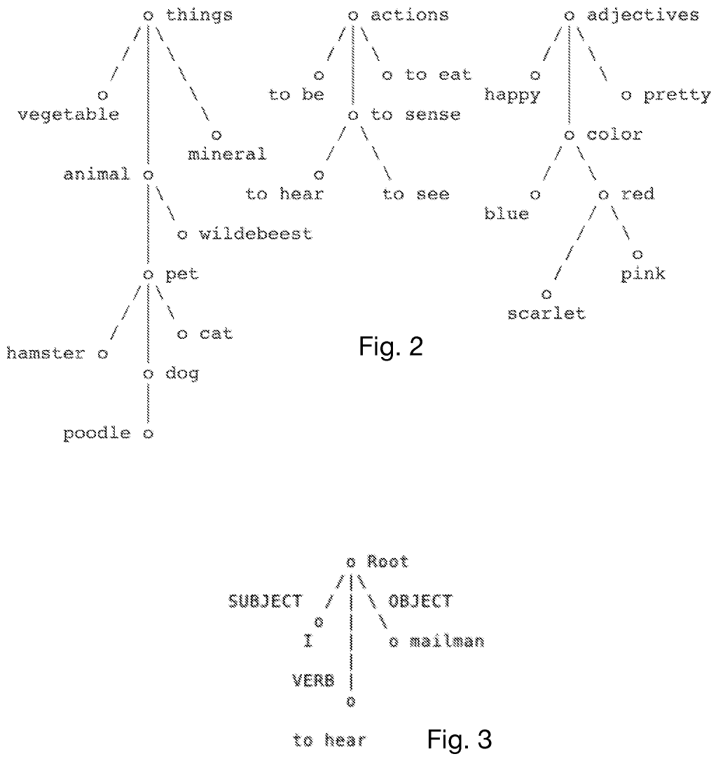

The system's vocabulary is defined hierarchically. As depicted in FIG. 2, a poodle is a dog, a dog is a pet, a pet is an animal, and so on. Concepts for hamster, cat, dog and wildebeast are children (hierarchically) of the concept for animal. When one asks if a wildebeast is an animal and whether it shares some features in common with dogs, the answer will be “yes.” However, there is no upward path from wildebeast to pet. Therefore a wildebeast is not a pet.

Vocabulary definition may have multiple synonyms, such as “hot dog”, “hot dogs” and the name “hotdog-1”. To reference this definition, one could refer to it by any of the synonyms, e.g. “the dog ate a hot dog” or “the dog ate a hotdog.” Plural and singular forms may be group together; however, this is not a requirement. The vocabulary may also be built to distinctly include singular and plural forms. As a non-limiting example, the combined forms are utilized below:

define hotdog-1

| | |
|---|---|
| label | hot dogs |
| label | hot dog |
| label | hotdogs |
| label | hotdog |
| orthogonal | food-1 |
| child-of | food-1 |

When a word has two or more distinct meanings, there may be two or more definitions. For example, a ball is round, a ball has the quality of being a certain color, a “ball” is a toy. A “ball” might also be a formal dance, with an orchestra and glass slippers.

define ball-1

| | |
|---|---|
| label | balls |
| label | ball |
| child-of | toy-1 |
| wants | color-1 |
| wants | size-1 |
| related | round-1 |
| related | play-1 |
| wants | shape-1 |

define ball-2

| | |
|---|---|
| label | balls |
| label | ball |
| child-of | party-1 |
| related | loud-1 |
| wants | volume-1 |

In order to distinguish the two forms of ball from one another, hints may be added to the definitions. If “the ball is red,” chances are that the correct sense of the word “ball” will be generated because of the hint that says “ball-1 wants color-1”. Once the system has been processing data for a while, reliance on hints in the vocabulary become less important. Instead, the system will look to memories and context when trying to determine the sense of a word.

### Grammar

Grammar defines how the vocabulary elements can be combined. Consider the statement: “I hear the mailman.” The words “I” or “mailman” may play the part of a subject or object. The word “hear” can only take the part of a verb. Using a grammar rule like this, the phrase “I hear the mailman” may be recognized. For example:

grammar_rule=subject+verb+object

The system tags parts of speech, such as the subject, verb and object, and places them into a data structure that represents the statement. See FIG. 3. Once the knowledge is captured, the original statement is no longer needed.

As depicted in FIG. 3, in the system's terminology, each of the vocabulary elements, “I”, “to hear” and “mailman”, is called a concept. Any combination of concepts is called a complex concept or CC. Compiling the statement “I hear the mailman” produces a CC data structure that resembles the diagram in FIG. 3. A CC can be indexed, stored, recalled, compared, and transformed. For example:

>>i hear the mailman
You do hear the mailman.
>>what do i hear?
You do hear the mailman.
>>do i hear the mailman?
yes. You do hear the mailman.
>>what do i do?
You do ask do You hear the mailman.

### Orthogonality

Orthogonality may be defined as concepts or complex concepts that are orthogonal when they exist in opposition, contrast, or inconsistency to one another. Returning to the definition of the concept hotdog-1, as a child of concept food-1, the concept hotdog-1 becomes part of a class that may include hamburgers, potato chips, chicken parmigiana and so on, provided that they are also children of food-1.

define hotdog-1

| | |
|---|---|
| label | hot dogs |
| label | hot dog |
| label | hotdogs |
| label | hotdog |
| label | wiener |
| orthogonal | food-1 |
| child-of | food-1 |

define hamburger-1

| | |
|---|---|
| label | burger |
| label | hamburger |
| orthogonal | food-1 |
| child-of | food-1 |

Hot dogs are food. Hamburgers are food. But hamburgers are not hotdogs. Indicating orthogonality makes it possible to tell them apart. The directive “orthogonal food-1” instructs the system that hotdogs and hamburgers are exclusively different than other concepts that are also declared orthogonal to food-1 or one of its parents.
>>what are hotdogs?
hotdog is food.
>>are hotdogs hamburgers?
no. hotdog is not hamburger.

As orthogonality helps to differentiate objects, it applies to attributes, too. An ATTRIBUTE is an adjective or propositional phrase, typically, though it can be a binary large object (BLOB), such a thumbprint, picture or voice scan. The “red dog” is not the “blue dog”, the “first dog” is not the “second dog”, and the “dog in the restaurant” is not the “dog in the library.”

>>the first dog sees a cat
the first dog sees a cat.
>>the second dog sees a squirrel
the second dog sees a squirrel.
>>does the first dog see a squirrel?
maybe. the second dog sees a squirrel.

Orthogonality may apply to whole clauses playing the part of subject or object. For instance “the party at the beach” may be orthogonal to “the funeral for my uncle.” Tests for orthogonality of more complex CCs like these may take place by semantic evaluation. The semantic evaluation test compares the knowledge contained within the two more complex CCs by deeper, recursive processing that may generate a product that understands the meaning of the two more complex CCs and identifies the two CCs as incompatible.

### Inheritance, Orthogonality, and Truth

For computing with knowledge, a user needs to be able to ask whether something is true or false, or whether the answer is known. Truth is important for steering processing, and invoking inferences and memories. Truth motivates computation.

The system's vocabulary is built of taxonomies. Every concept, except for the very top concepts, is the child of another. Some are the children of many. A toy is a thing; a ball is a toy. Inheritance is functionally broken, however, when orthogonality is detected. A blue ball is not a red toy, for example. Just as individual concepts can be the children of others, whole CCs (complex concepts, described above) can be the children of other CCs.

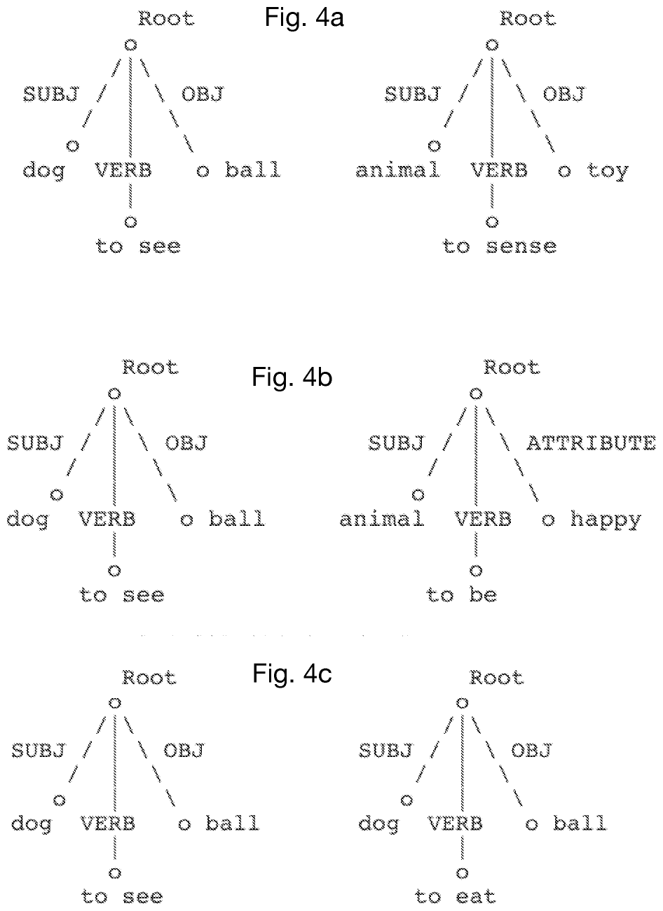

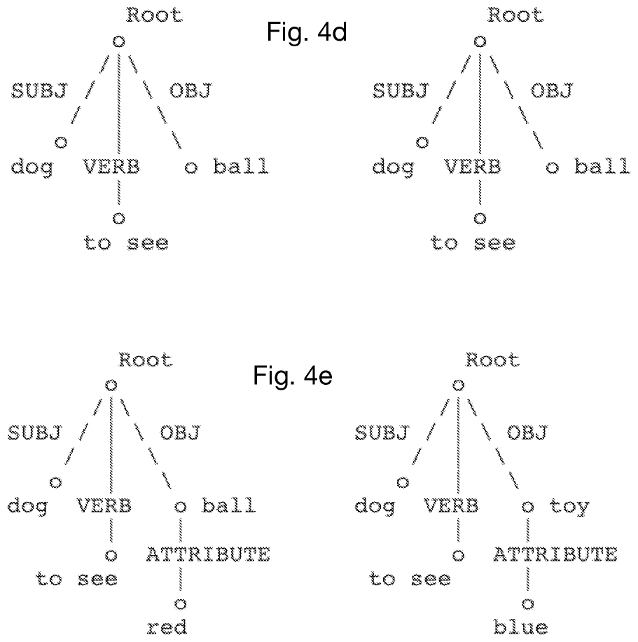

For one CC to be the child of another, the child CC must contain the same basic parts of speech as the parent. In the system parlance, two CCs have the same shape. Furthermore, each of the child's constituent concepts, taken in pairwise comparison to the parent's, must be child concepts, or be the same. For example, as depicted in FIG. 4a, the CC on the left is a proper child of the CC on the right. Each of the concepts in the left CC is a child of each of the concepts on the right, and the two CCs have the same shape. As depicted in FIG. 4b, the next two CCs do not have a child/parent relationship because they have different shapes. This is because links are different, such as OBJECT versus ATTRIBUTE. They also lack pairwise inheritance in all but the OBJECT. As depicted in FIG. 4c, the shape is the same. The corresponding concepts are identical. In fact, the CCs are identical. A concept can be a child of itself and the child/parent relationship is valid. As depicted in FIG. 4d, there are two CCs that do not share a child/parent relationship because at least one of the constituent parts-of-speech is not a child of the other, even though they have the same shape. In this case, there are two verbs, “to see” and “to eat”, neither of which is a more specific instance of the other or the same. As depicted in FIG. 4e, the constituent concepts of “dog sees red ball” (“dog”, “to see” and “ball”) are all proper children of the corresponding concepts in the itinerant parent. The shape is also the same. However, the concepts occupying the OBJECT positions are orthogonal because they bear orthogonal ATTRIBUTEs (“red” versus “blue”). Thus, even though each of the concepts that make up the two CCs have child/parent relationships, orthogonality between the concepts breaks the child/parent relationship between the CCs, i.e. testing to see if the left CC is a child of the right, the answer is NO.

In FIGS. 4a-4e, the question of “is the CC on the left a child of the CC on the right?” may be asked. The answers to this question are TRUE, MAYBE, TRUE, MAYBE and FALSE, respectively. “TRUE” signifies that the relationship is established that is one CC is the child of another. An answer of “FALSE” means that the two are the same shape, but in opposition, due to an orthogonality. “MAYBE” means that there is insufficient shared structure to answer the question. For instance, in FIG. 4b, the CC representing “the dog sees a ball” neither is nor isn't a child of “the dog is happy”. Accordingly, the answer is MAYBE, then the two CCs can't be compared.

Other parts of speech within CCs will also affect the child/parent comparison. Negation, for example, in a comparison of “ball is not blue” (child) “the ball is red” (parent) will return TRUE. If they are reversed, testing to see whether “the ball is red” is a child of “ball is not blue”, the answer will be MAYBE.

Tense can be attached to verbs and attributes. This also affects child/parent comparisons. Take, for example, “the ball is blue” tested as the child of “the toy was red.” The answer is MAYBE because the two CCs occur in different tenses. Orthogonality mostly or only applies when attributes are in the present tense. For example:

>>the ball is red
the red ball is red.
>>debug eval the ball is red
the red ball is red.

### “True”

>>debug eval the ball was red
the red ball was red.

### “Maybe”

>>debug eval the ball is blue
the red blue ball is blue.

### “False”

>>debug eval the ball is not grey
the red not grey ball is not grey.

### “True”

There are a number of situations where the system may ask itself “is this CC a child of that CC?” or “is this CC true?” The answer may be unknown, i.e. “is this CC true?” could return MAYBE. Given an answer of MAYBE, the system will often initiate a more aggressive search for the answer in what is called “self talk.” The system will reformulate a question to itself (in human language, such as English) and process it as if it came from the user. Self-talked input may cause inferences to fire, memories to be restored or motives to be advanced, all of which can lead to a more definitive answer to “is this CC true?” Complex concepts may also be processed to produce novel information via a plurality of explicit and implicit inference modules.

### Context

As the system processes, it builds and updates running context and discourse buffers. These provide a background against which the system can better understand what might come next. A simple illustration of the role of the context is the resolution of pronouns. Referring to something by “he”, “she” or “it”, the user expects the program tol recognize these as wildcards for some definite noun or noun phrase that came before.

>>i see the dog

### You see the dog.

>>it is hungry
the hungry dog is hungry.
The “it” in the statement above is an immediate reference to a dog fetched from the context. An example matching a noun phrase:
>>the princess loves luigi it
the princess loves luigi.
>>mario hates it
mario dislikes the princess loves luigi.

“W” words (who, what, when, where and why) can also be satisfied by the context.

>>the cat meows
the cat meows.
>>the dog barks
the dog barks.
>>what meows
the cat meows.
>>does something bark?
yes. the dog barks.
The context grows as the program runs. Older knowledge is pushed to the back. New entries are added to the front. By this, the resolution of ambiguous references evolves to favor the new. The context following “the cat meows” and “the dog barks”:
Break in debug at the start:
debug>xspeak 1
You say the dog barks. the dog barks.
You say the cat meows. the cat meows.

The CCs of the context are the product of parsing, disambiguation, and an election process that arrives at a single input interpretation. The product may be constructed from a combination of clean and dirty concepts. Clean concepts are those that are sourced from the vocabulary, such as CCs, but have not been modified. Dirty concepts are those that have been modified, such as MCCs and the like. An example of a clean concept is “dog.” An example of a dirty concept is “happy dog.” Below, depicts two concepts for dog, one dirty and one clean:

>>happy dog
dog to be happy.
>>break
Break in debug at the start:
debug>list dog
Meme: default
(clean text) dog->dog-1 (clean), MID 10000
(context text) dog->dog-14c57 (dirty), MID 10000

For any vocabulary concept, there will always be a clean original. The original is never touched. Rather a dirty copy is created and modified when necessary. During processing, the system strives to create as few dirty copies as possible. Two copies of “dog”, clean and dirty, may be sufficient for the life of a session. A case where the system will create multiple dirty copies is where an orthogonality is detected.

>>the happy dog has food
the happy dog has food.
>>the sad dog does not have food
the sad dog does not have food.
>>is the happy dog the sad dog
no. the dog is not the happy dog.
>>break
Break in debug at the start:
debug>list dog
Meme: default
(clean text) dog->dog-1 (clean), MID 10000
(context text) dog->dog-17028 (dirty), MID 10000
(context text) dog->dog-1f64f (dirty), MID 10000
The above depicts two dirty dogs: one is happy; and, one is sad.

### Dynamic Concepts

A dynamic concept is one that is created at runtime. Dynamic concepts are used for names and addresses. For example, below is the creation of “rover”, the name of a dog.

>>my dog's name is rover.
your rover dog belonging to You is rover.
>>break
Break in debug at the start:
debug>list rover
Meme: default
(context text) rover->rover-15099 (dynamic_recorded), MID 10000
Because dynamic concepts are not sourced from the vocabulary, their labels (like “rover”) have to be stored along with any save sets that reference them.

### Hash Tables

Hash tables are a mechanism that aid in the storage and retrieval of data. The simplest form of hash table is a direct hash, such as a fixed collection of slots numbered from 0 to N−1. To use the hash table, one generates a number from 0 to N−1 as an index into the table. The index chooses the slot. The slot contains something of value. For illustration, imagine an old hotel with a wall of wooden box-slots behind the front desk. The slots contain room keys. There is one slot per room. If you have the room number, you can check the slot for the room key. The room number is the index. The room key is something of value to be found in the slot. Now, suppose that there are many more rooms in the hotel then there are boxes. One would have to share box-slots between rooms. In order to map M rooms onto N hash table slots, one could create an index that is equal to “(room number) modulo N.” In this case, the same hash slot will be used for room 1, room 1+N, room 1+2N, and so on. If the hash table is built to accommodate multiple data sets, then overloading a hash slot won't replace the information within it when new data are stored. Rather, a slot will accumulate additional stored data and grow.

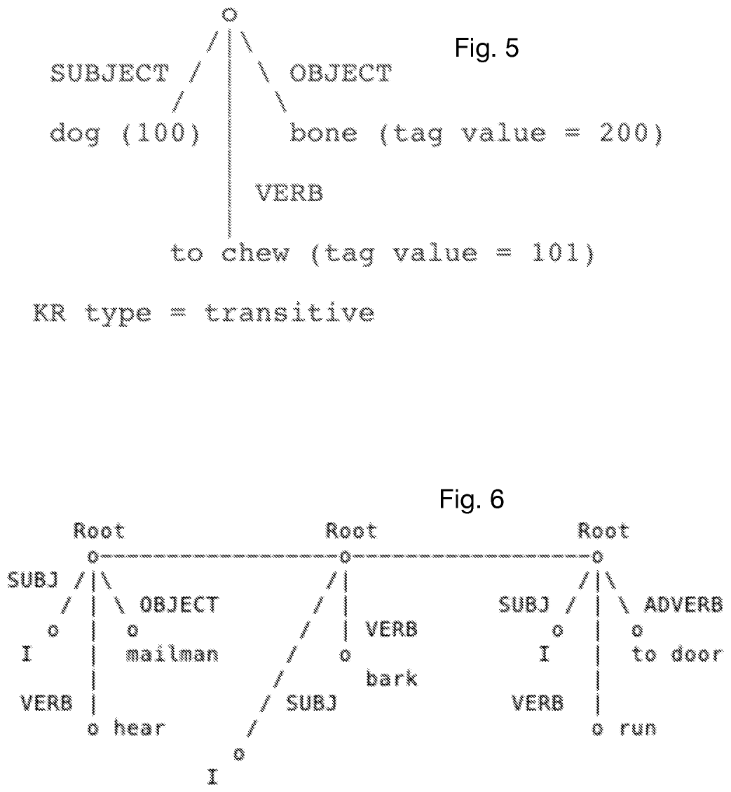

Hash tables and slots are a mechanism that the system uses to store and retrieve CCs. Hashes are used because individual concepts are associated with tag values. As depicted in FIG. 5, the concepts for “dog,” “to chew” and “bone” might have tag values 100, 101 and 200, respectively. These can be combined to create a hash for the CC that represents “dog chews bone.” A simple hash would be the sum of all of the values, such as 100+101+200=401. To store or retrieve the CC associated with “dog chews bone”, one locates a hash table slot associated with the number 401 and finds a reference to “dog chews bone.” This retrieval system could be used in other ways, such as, if asked “does the dog chew a bone?” The hash would again be 401.

Unrelated CCs can yield the same hash value. This will cause them to share a slot. Overloading is permitted, i.e. many CCs can share a single slot. Hash slots include extra information to verify that a “hit” matches the values that created the hash. By this, the hash table becomes the long-term directory for locating CCs and searching for knowledge.

### Hash Vines

Guided by the hierarchical organization of the vocabulary, the system can recognize a CC containing specific knowledge to be the child of a CC containing abstract knowledge. It is useful for answering questions, invoking inferences, and restoring memories. For example, “pet chews bone,” “pet action bone”, “animal chews thing”, “thing action thing” are all abstract cases of “dog chews bone.” Any of these abstractions can hash to find “dog chews bone.” Therefore, a user can ask the system “does an animal chew something?” and the answer is yes; a dog chews a bone.

>>a dog chews a bone
a dog chews a bone.
>>break
Break in debug at the start:
debug>eval animal chews something
animal chews thing.

### “True”

debug>cont
>>does an animal chew something?
yes. a dog chews a bone.
The vocabulary parents of concepts “dog”, “to chew”, and “bone” create the hashes. The system gathers each concepts' parents into a linear list. For non-limiting illustration, suppose the parents for hash variable “dog” include “pet”, “animal” and “thing.” The parents for “bone” might be “body part” and “thing.” “Chew” might simply be classified as an “action.” Given all the parents, they can be placed side-by-side:

| hash | hash | hash |
|---|---|---|
| van 1 | var 2 | var 3 |
| thing | action | thing |
| animal | chews | body part |
| pet | : | bone |
| dog | : | : |
| : | : | : |

In the system parlance, the ordered sets of concepts are called “hash vines” by virtue of the way they hang down from least-specific to most-specific, and by the way the code climbs them. Hash searches are bottom-up and breadth-first, i.e. more-specific matches are favored over less-specific. The code reaches the more specific hashes first, like a gorilla climbing a set of vines. Moreover, by the way they are traversed, hash vines can support “occlusion” such that more-specific hashes are reached before less-specific hashes, and thus will take precedence in a search. An example of where hash vines may apply: “Animals like water” is the generalization. “Cats do not like water” is more specific. Thus, a search for “do cats like water? (no)” may locate a match before “animals like water (yes).”

### Memories

The above example of how to program a dog, considers a simple sequence of statements as a description of what a dog will do when the mailman comes. A person could visualize the behavior of the dog because people have worldly experience. The system has no experience with dogs and the things that dogs do. In order to approximate an understanding of a dog, the system has to learn about dogs. It does this by reading programs about dogs. As the system reads, it collects, stores, indexes, and groups dog knowledge (CCs) into neighborhoods. These neighborhoods are called memories. Memories are saved into a backing store, such as disks, databases or other instances of the system acting as memory-servers, in bunches. The indexes used to store and retrieve memories are called triggers. They are organized and accessed with hash vines. At runtime, the presence of one or more triggers may cause the system to restore a memory creating restored complex complexes (RCCs) and restored memory processed complex concepts (RMCCs). Hearing the mailman and running to the door could resurrect a recollection of barking, for example.

Memory may be defined as a neighborhood of a context, saved, and indexed for retrieval. Considered as data, a memory is a short string of CC data structures, fetched in the order in which they were stored. As depicted in FIG. 6, there are three CCs in the memory that contains: “I hear the mailman,” “I bark” and “I run to the door.” The three CCs are a snippet of the running context recorded and indexed for retrieval at some later time.

In the below example, a non-limiting illustration of memories at work is detailed. This first block of code is the input to the system that is used to create a memory:

the weather was beautiful
the sun was shining
i walked on the beach
i lost my dog
Memories are stored in binary fashion to a backing store, such as file, database or other copy of the system. A subsequent session may access these memories. The following is a demonstration of the retrieval of the memory above in a subsequent system session:
>>i walked on the beach
You did walk on the beach.
>>the sun was shining
the shining sun was shining.
>>did i lose something?
yes. You did lose your dog.

The conditions that invoke a memory needn't exactly match the triggers that stored it. A subset of triggers may be sufficient. Nor do they have to appear in order. General memories may be invoked by more specific triggers. A memory involving house pets may be resurrected in conjunction with a trigger that refers to a cat or dog, for an example see “hash vines”, above. The system will attempt to substitute the specific concepts that trigger a memory into the abstract concepts it may contain, i.e. “cat” may be substituted to replace “house pet” in the restored memory. Since runtime memory triggers are found in the context, a restored memory will likely contain some CCs that duplicate elements of the context that triggered it. A memory will often also contain some CCs that are not already resident in the context. It is this extra knowledge that provides expectation for what might come next, such as “I lost my dog” in the example above. Multiple memories can be restored simultaneously. Unrelated memories can combine. By this, the system can generate fresh observations under novel conditions. The illusion of intuition occurs when conditions cause the system to resurrect old memories and apply them to new situations and new actors.

Orthogonality is an important tool for maintaining coherence in memories. In cases where restoring a particular memory would create an orthogonality violation (causing the dog to be both inside the house and outside the house, for instance), the itinerant memory will be skipped, i.e. not restored.

For the time they are relevant, memories are intertwined with the CCs of the recent context and with each other. The memory's constituent concepts (dog, weather, etc.) are merged with the dirty concepts of the current context. When a memory loses relevance, it is removed from the context. The dirty concepts (dog, weather, etc.) are rebuilt and stripped of the contributions from the retired memory. Though the memory may be removed, any newly generated knowledge derived from it will become part of the permanent context. The removed memories ephemeral presence may have permanent effects.

Memories have multiple uses. When the system is trying to derive the correct interpretation of user input, it may consult memories. If a particular interpretation, in combination with the context, invokes a memory, then the system will favor that interpretation over other possibilities that do not. For instance, if the user tells the system “the dog sees the ball”, memories about a dog and a ball (as a toy) are going to help the system decide that this is a more likely interpretation than a dog watching a large gathering with dancing and an orchestra (another kind of ball).

How are memories created? Memories come from regular language input, like the statements of the dog program or interactive banter about food. When instructed to do so, the system will save snippets of the context from time-to-time, along with index information. Later, when similar input resembles the indexes (triggers), a saved memory will be restored. Creating or restoring memories doesn't interfere with other system processing. Accordingly, memory creation and/or restoration can be enabled during regular interaction to build even deeper memories.

There are multiple categories of memories. For example, four categories of memories with the designations of “layer 1”, “layer 2”, “layer 3” and “layer 4”. The difference between the designations are the thresholds to be met before a memory is eligible for restoration. Layer 1 is intended for memories that require no more than the mention of a pertinent concept as a condition of being restored. For instance, a memory about the sun, “the sun is bright”, “the sun is in the sky”, “the sun is round”, “the weather is not raining”, can be safely resurrected whenever the sun is mentioned. Layer 4 memories, on the other hand, might concern specific situations, such as the presence of the mailman at the door, and be reserved for cases where multiple conditions match. The layers and thresholds are configurable. Their uses are up to the programmer/user.

Context and memories are not the same thing. The context provides the system with a background against which to understand new input. Likening the context to a person's mind, the context is a collection of the things that the system is presently concentrating upon. Memories, on the other hand, are knowledge that is superimposed onto the context opportunistically, and usually temporarily. Memories are akin to notions that pop into one's head and later disappear. Complex concepts (CCs) may be read, collected, stored, indexed, grouped, and transformed into a plurality of memory processed complex concepts (MCCs) be means of memory modules.

### System Save Sets

Save sets are used to store memories, motives, and whole-sessions. Via save sets, one can store the complete state of the system today and resurrect it tomorrow. Save sets provide an avenue to serve the system functionality from stateless servers, i.e. the clients can keep their own state. Save sets contain a configurable number of sections that can record context information, discourse buffer information, saved questions, dynamic concepts, i.e. concepts created outside the vocabulary, and other sections. Save sets may rest in files, in a backing store or be traded between copies of the system. Save sets are knowledge storage without the presence of language.

### Text Input

Computation is motivated by changing conditions, such as a fact learned from another copy of the system, some input from the programmer, a news feed update or input from an outside agent, i.e. a sensor or robot. The system, running as a daemon, can listen to an arbitrary number of connections. Depending on how the connections are opened, the system may expect simple English, a system save set or an exchange via or by means of the systems robot API.

In daemon mode, the system listens for user connections on a TCP port. This port is used for interaction with humans, speech interfaces and a web sockets shim. Interactive connections will typically drop in and out of debug mode to exchange out of band data. Whether invoked as a daemon or interactively, the system opens a default connection to interact with the programmer in simple English. For example:

>>i am happy
You are happy.
>>you are sad

### I am sad.

>>how are you

### I am sad.

>>how am i
You are happy.
>>my dog knows that his ball is in the water
your dog knows dog's ball is in the water.
>>what does the dog know?
your dog knows dog's ball is in the water.

Live interaction is a way for the programmer to motivate and test the system computation. Live interaction is also convenient to simulate exchanges with outboard sensors or robots. Any input provided through the default interface is recorded verbatim and also is recorded as “speaker says . . . ”, i.e. the “speaker” is the user, the programmer, the person interacting with the system, the system speaking to itself in self talk mode, etc. Programs may react to command line propositions, such as “the ball is red” or with the derived fact that speaker input provided the proposition, e.g. “speaker says the ball is red.”

### Robot Interface

To connect with a sensor, robot and/or any other electronic machinery capable of interacting with the system, the programmer designates a concept as a robot, for a non-limiting example, and opens a connection to it. For example:

a robot's address is 192.168.0.100:300.
the robot's name is freddy.
This designates a robot and gives it a name. One can subsequently direct the robot in the imperative tense. For example:
>>tell freddy put the ball in the bin.
The robot will receive a list of field/value pairs, delimited by a start and end statement. For example:
start
tag=4839
subject=freddy
command=put
object=ball
color=red
objprep=bin
prep=in
end
The robot may respond with a status code and an optional simple English message. A response of “Y” indicates that the action was completed. For example:

### 4839:Y

A response of “N” means the action failed. An optional reason may be provided by the robot. For example:
4839:N:freddy does not have ball

Robot interfaces are asynchronous. At any time, a robot may provide simple language input via its connection to the daemon. This is useful for forwarding unsolicited updates, such as detection of the mailman in the dog program.

### Outbound Text Connections

A system daemon can open a text channel to any external program capable of interacting with the system or to other copies of the daemon, such as:

a daemon's address is 192.168.0.101:4144.
the daemon's name is freddy.
tell freddy hello.
In the above example, the local copy of the system will open a connection to a remote copy and send “hello.” When the remote copy responds, it's response will be prepended with “freddy says” to create “freddy says hello” within the context. By this, the source of the input is identified and its value may be associated with the reputation of the source.

### Outbound Context/Memory-Sharing

The system can also open a channel for sharing system binary save sets. This is particularly useful for sending save sets that contain a portion of the immediate context in anticipation of receiving remote system memories in return. For example, a memory bank's address is 192.168.0.102:4144. When a remote daemon connection is opened, the local copy of the system will automatically share out sections of the context and receive remote memories in return. By this, a local copy of the system may benefit from the experiences of remote copies of the system. Unsolicited memories and updates may be received from remote copies of the system while a connection is open.

### Motives

The system has a facility where applications may be crafted to pursue specific goals. For non-limiting illustrative purposes, for example, the dog is told by a camera-robot that it has detected a person's face. The user might wish to exercise a decision tree that decides whether to growl or wag the dog's tail, depending on whether the face appears to be friendly. This goal-seeking facility is called Motives. Motives are hand-crafted, N-way branching, overlayed, restartable decision trees. Motives coexist with and combine with memories in order to affect context-dependent behavior.

Each motive is a block of code initiated by a test. When the test evaluates TRUE, the block gains focus and its contents execute. The contents of the motive are simple English statements. A non-limiting illustrative example of system syntax is shown below:

MotiveName: start

### Test:

### Contents:

Branches: see-a-face, start
MotiveName: see-a-face
Test: you see a human face.

### Contents:

you are afraid.
tell body-robot crouch.
tell vocal-robot growl.
tell vision-robot analyze-face.
Branches: friendly-face, unfriendly-face
MotiveName: friendly-face
Test: face is friendly.

### Contents:

you are not afraid.
you are happy.
tell body-robot stand.
tell body-robot wag-tail.
tell vocal-robot happy-bark.

reset friendly-face.

reset see-a-face.

Branches: see-a-face
MotiveName: unfriendly-face
Test: face is unfriendly.

### Contents:

tell vocal-robot angry-bark.

### Branches:

The ‘MotiveName’ field provides a label for the block. This label can be used as a branch target from other blocks. The ‘Test’ is a condition that, when true, will cause the motive block to gain focus. The ‘Contents’ are statements that execute when the block gains focus. The statements can be a mix of propositions, inference templates, and imperatives. ‘Branches’ nominate potential next blocks, making them standby-active. Once a block is active, its ‘Test’ is armed and will remain that way until the block is reset or executed. Note that many blocks can be on active-standby at any time. Focus may shift between blocks that are on separate paths. This makes it possible to pursue many sets of goals and motive blocks simultaneously.

Motives interact with memories, causing memories to be restored and retired as a side-effect of the new information a motive may add to context. Unlike memories, however, the contribution of motives is permanent, and becomes part of the ongoing context.

In the case where a motive becomes active, and where its contents will create an orthogonality conflict with the context, portions of the context may be graduated into the preterit. For example, if the context says “dog is inside the house” and a newly activated motive says “dog is outside the house”, the motive wins and the context changes to say “the dog was inside the house.”

A system server may be invoked with a set of motives pre-activated. When clients or users connect, the motives will direct their interaction. Additionally, clients may provide their own motives and the state of the motives to a system server. By this, individual clients can pursue their own goals on a generically-programmed system server platform.

### Belief Systems

There are mode and debug flags in the system that allow the programmer to modify the system's interpretation and computation. One flag, “verbatim”, controls whether speaker interaction is taken at face value. With the “verbatim” flag unset, input of a statement like “the ball is red” records only “speaker says the ball is red.” For example:

>>debug unset verbatim
>>if i say a thing is red then a thing is blue
if You say a thing is red then a thing is blue.
>>the ball is red
the ball is red. a blue ball is blue.
>>why
a blue ball is blue because You say a blue ball is red.
Non-verbatim processing makes it possible to build simple belief systems that arrive at conclusions that differ from or are in conflict with user or robot/sensor input.

### Debug

The program includes extensive debug facilities. For example:

### Commands:

DEBUG symbol [location]—or—
BREAK symbol [location]—or—
SET symbol [location]

Increment debug count for routine/process/flag,

and optionally stop at listed locations.

“location” is one of {start, loc[1-3], finish, all}

NODEBUG symbol—or—
UNSET symbol

Decrement debug count for routine/process/flag.

CLEAR symboln Zero the debug count for routine/process/flag.
DUMP [n]

Dump optional argument concept (if concept).

Dump optional conchain (if conchain).

“n” chooses conchain element.

RDUMP [n]

Dump recursively.

LIST label

Show all symbols matching label.

### WORDS

Dump pre-prepared word list.

### LISTM

Shows loaded motvs.

SHIFTN number

Shifts meme processing to motv N.

SHIFT name

Shifts motive processing to motv by name.

### STOP

Stop.

S[R]DUMP symbol

Dump symbol from clean symbol table.

C[R]DUMP symbol

Dump symbol from context.

M[R]DUMP symbol

Dump symbol from MID symbol table.

### X[R]DUMP n

Dump nth CC from context.

### D[R]DUMP n

Dump nth CC from discourse buffer.

### Q[R]DUMP n

Dump nth CC from questions buffer.

SPEAK [n]

Speak optional argument concept (if concept).

Speak optional conchain (if conchain).

CCSPEAK label

Speak CC from context.

XSPEAK [n]

Speak nth context entry.

DSPEAK [n]

Speak nth discourse entry.

“n” chooses conchain element.

### SQSPEAK/SQ[R]DUMP

Speak/dump the saved question, if any.

### A[R]DUMP/SPEAK n

Dump nth anaphor candidate.

PARSE string.

Parse and read back the input.

EVAL string.

Evaluate the truth value of the input.

REDIR flag.

Output debug for “flag” to stderr. “Flag” may additionally be specified as “journal”, in which case the journal output is redirected.

STDERR ipaddr port.

Send stderr to a socket waiting at ipaddr:port.

### ARGV

Print out the argument vector for this system invocation.

### Graphical User Interfaces

The system may utilized any graphical interfaces that are compatible with the system. For a non-limiting illustrative example, the system has two limited use graphical interfaces: (1) A Windows-based interface provides a SAPI4 connection to speech engines; and (2) A more comprehensive HTML5/websockets-based GUI is helpful for testing programming and vocabulary.

### Input Grammar

The system attempts to match user input against a set of input patterns. A plurality of input patterns will compete to match the input. The result is a best-fit interpretation. At the lowest level, the “fit” is a parts-of-speech match, where the system does not presuppose the meaning of the matched text. As a result, a plurality of permutations may be generated, with a plurality of different meanings. Further system processing decides which interpretation is the most relevant.

The following is a cursory non-limiting description of the process of interpreting simple English input. Taking an input, verbally or electronically, of “boy saw bat,” the system might generate CCs that represent “bat” as a winged mammal or as a wooden baseball mallet. “Saw” could mean “viewed,” or it could mean “cut in half.” A simplified system input grammar rule that matches “boy saw bat” might look like this:

define xxx

| | |
|---|---|
| label | sentence |
| rule | $c'things'0! $c'actions'1! $c'things'2 |
| map | SUBJECT, VERB, OBJECT |

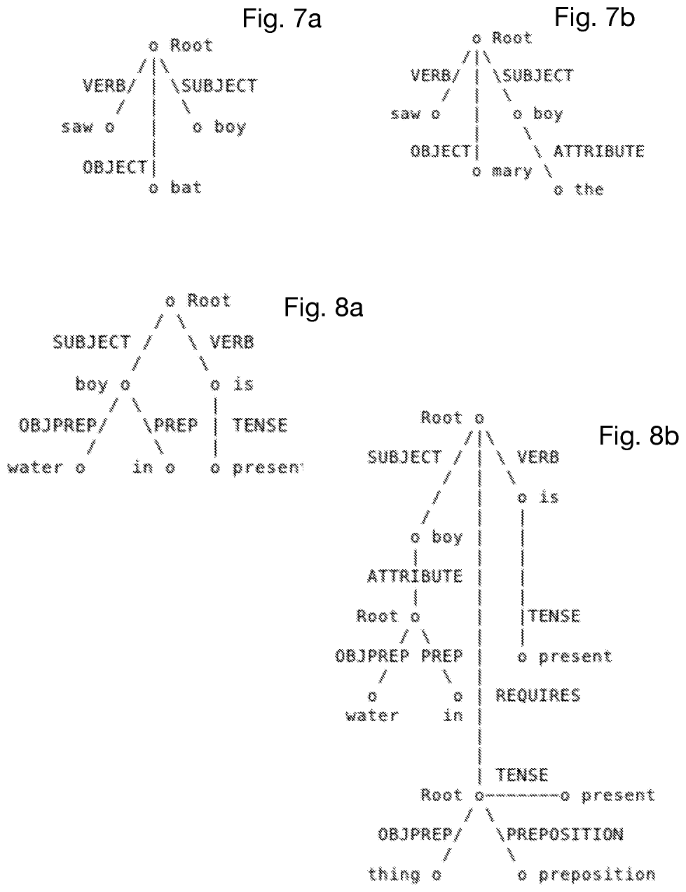

‘$c’ is a simple directive that says “look for a concept that is the child of ‘things.’” If matched, assign the result to the 0^{th} argument. This pattern can match a wide variety of input, such as the sentence “ball hit wall” could also fit the pattern. The ‘map’ directive describes how to build the CC from the matched tokens. There will always be a root node. From that, elements are attached, one level deep. The SUBJECT is in the 0th position in the map directive. Therefore, whatever matches $c ‘things’ 0 becomes the SUBJECT. See FIG. 7a.

When an input pattern matches, many complex concepts (CCs) may be created. Each is a permutation representing a possible interpretation of the input. Each incorporates a collection of clean and dirty concepts. English input may parse into a CC that is many levels deep. Lower levels may correspond to English clauses such as prepositional phrases or noun phrases. The top level reflects the sentence framework. CCs are constructed by assembling intermediate products of parsing. The matching process descends and rises, striving to build from the bottom up. Expanding a previous examples and figures, the user might match more complicated utterances such as “the boy saw the bat,” or “the boy saw mary” using the patterns below. In this case, the rule ‘zzz’ represents a subject or object with an optional article.

define xxx3

| | |
|---|---|
| label | sentence |
| rule | $r'subobj'0! $c'actions'1! $c'subobj'2 |
| map | SUBJECT, VERB, OBJECT |

define zzz

| | |
|---|---|
| label | subobj |
| rule | [$c'article'0! ]$c'things'1 |
| map | ATTRIBUTE, ROOT |

Grammar rules can invoke other rules. The r‘subobj’0 in the above example instructs the system to test sub-rules of the type ‘subobj’ and assign matches to the SUBJECT position. By virtue of delegating the construction of individual components (subject, object, etc.) to recursively invoked rules multi-level CCs are constructed. Rule components that appear in “[ ]”'s are optional. See FIG. 7b.

At each level, upon matching input, the system assembles CCs and passes them to post processing routines (called ‘mprocs’). These routines may transform the shape of the CC, eliminate a CC, or cause global side-effects. For example:

| /* Where is x? | |
|---|---|
| /* | |
| define sent-where | |
| label | question |
| rule | where $c‘tobe’0! $r‘csubobj’1 |
| map | VERB,SUBJECT |
| mproc | SPEAK |
| mproc | CHOOSEONE |
| mproc | PULLWHERES |
| mproc | TOBECOMPACT |
| mproc | PUSHTENSE |
| mproc | REQUIREWHERES |

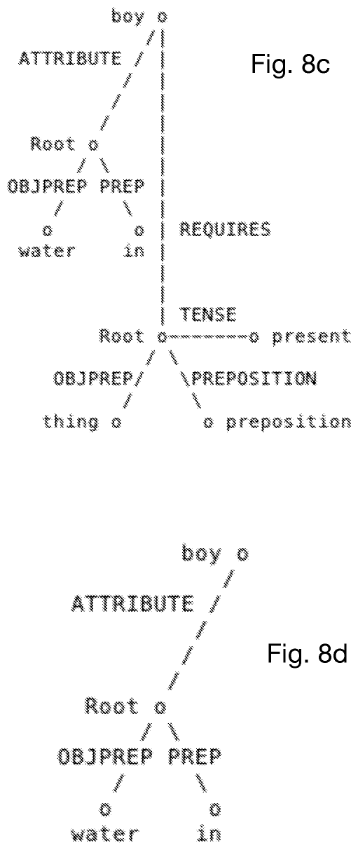

Post processing routine selection starts at the bottom and proceeds upwards. The routines are working to answer a question about the location of something. Assume for non-limiting illustration that a previous sentence told the system that “the boy is in the water.” As depicted in FIG. 8a, a CC representing the question “where is the boy?” may take the form of FIG. 8a. Once the question parse is complete, the mproc routines will reshape the question to produce an answer. Recall that CCs are constructed from a combination of clean and dirty concepts. If the boy were in the water, the dirty concept for “boy” would carry the attribute “in the water.” Accordingly, it is sufficient to match a question that says “boy preposition something” to “boy in water”, thereby answering the question.

As depicted in FIG. 8b, REQUIREWHERES tacks a REQUIRES tag onto the CC. The tag indicates that a prepositional phrase is a must-have to answer the question. PUSHTENSE grabs the tense of the verb and applies it to the requirement, making it more restrictive. Routine TOBECOMPACT changes the shape of the CC by removing the verb and placing the subject in the role of “Root.” PULLWHERES makes multiple copies of the CC. Each is the same as the original except that all but one prepositional phrase remains per copy. See FIG. 8c. CHOOSEONE selects the best result, and SPEAK voices it. See FIG. 8d. This says “boy in water.” In this simplified example, the use hashing and best-fit parsing was not shown.

### Text Grammars

In programming or where interaction via English or any other human language is needed, simple language is the key. The complex language of conversation or writing is not out of bounds. However, the potential for misinterpretation increases with complexity, nuance, and idiomatic use of language. For example, the phrase “Yo, dude!” may be interpreted as “hello” for most readers. The phrase “Yo, dude!” is not beyond the capability of a parser to understand; however, the phrase is not typically understood utilizing English grammar. Accordingly, the system does not have the specific grammar for interpreting the meaning of “Yo, dude.” In order to understand the meaning of the phrase, the system does offer preprocessing grammar for idiomatic language substitution. For example:

define yohomey1

| | |
|---|---|
| label | idiom |
| rule | yo[[,] $X1]] |
| map | ROOT, TEXT |
| xlate | &hello |

The above is an idiom rewrite. This is a text-based rewrite, substituting tokens recursively until the a terminal (like “&hello”) is encountered.

Sentences that contain multiple clauses and complementary or juxtaposed thoughts may also be parsed. The requisite grammar rules can be complicated, prone to error, and may be seldom used. For example, the sentence, “The inn can be restored and likely reopened as an existing use, though it is in a residentially zoned area with restrictions on new construction” may be interpreted. Complex language can be diced into chewable pieces. Some of the causal or restrictive relationships between clauses may get lost, but their proximity to each other will capture and preserve much of the flow of the sentence, such as “The inn can be restored. The inn will probably reopen. The inn can have guests. The inn can serve food. The inn is in a residential area. There are restrictions on new construction.” When the functionality to parse complex language is necessary, the system has additional grammar for pre-simplifying input, called “rewrites.” Rewrites are more complicated than idiomatic substitutions. They may invoke sub-rules and exploit the hierarchical organization of the vocabulary. Rewrites are mostly symbol manipulation where little to no semantic processing takes place. For example:

define clause-separator

| label | rewrite |
|---|---|
| rule | $B', '1!, $X2 |
| map | ROOT, TEXT, TEXT |
| xlate | ^{∧}1. ^{∧}2 |

The purpose of the simple example of a rewrite shown above is to separate two clauses joined by a comma. It would apply to input such as, “I see you, you see me.” The result would be: “I see you.” “You see me.” This next rule splits an input with two conjoined subjects into two separate statements.
#define 2OBJ $r‘csubobj-prep’5! and $r‘csubobj-prep’6

define split2obj

| label | rewrite |
|---|---|
| rule | [$r'adverbs' 1![,]! ]!2OBJ! $X2 |
| map | ROOT, ADVERB, TEXT, IGNORE, IGNORE, OBJECT, OBJECT |
| xlate | &[1^{∧}1 ]^{∧}5 ^{∧}2.& [1^{∧}1 ]^{∧}6 ^{∧}2 |

Given input of “mario and luigi see the princess”, the result would be:
“mario sees the princess.”
“luigi sees the princess.”

Idiom and rewrite grammars are invoked from inside the system before the main input cycle. Idiomatic substitutions occur first and are built of simple text-based rules. Rewrites can parse input with the help of the vocabulary.

### CC Grammar

The system has a grammar-based facility for matching internal CC data structures against templates. CC matching is similar to child/parent comparison discussed above, except an embedded orthogonality does not cause the match to fail unless the orthogonal component is part of the match template. For instance, a template that looks for “dog catches ball” will match “dog catches a red ball” and “dog catches a blue ball” with equal facility.

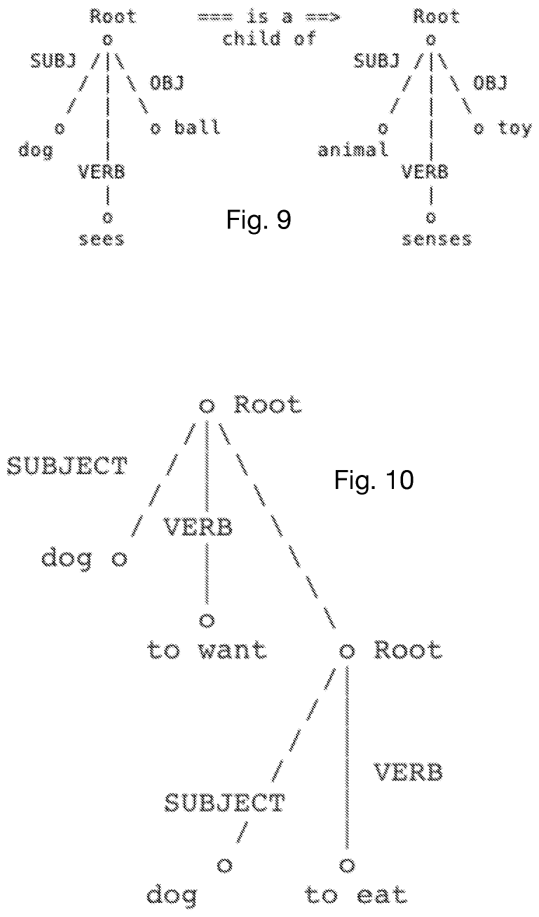

CCs can be children of other CCs. For example, “dog sees ball”, considered as a CC is the same shape as “animal senses toy”. This is true because each of its concepts, such as subject, verb, and object, are children of the corresponding parts of speech in the parent. See FIG. 9. A CC grammar rule that affects the example in FIG. 9 might look like this:
$I‘SUBJECT{&c\hat{ }animal\hat{ }0}‘0$I’VERB{&c\hat{ }to see\hat{ }1}‘1$I’OBJECT{&c\hat{ }toy\hat{ }2}’2
   When a match occurs, the results are assigned to arguments. In this case, argument 0 is assigned the SUBJECT; argument 1 is assigned the VERB; and, argument is assigned the OBJECT.

### Main Processing Loop

The system's main processing loop includes input, then parsing. Following parsing, post-processing “mprocs” guide interpretation, context update, output, and pondering. “Pondering” includes a collection of facilities that observe patterns in the context and invoke sub-processing. For example, it is the “ponder” portion of the cycle that recalls memories, runs motivations and exercises inferences. Much of the system's processing is recursive, and the main loop is no exception. Main processing loops can be invoked recursively by ponder routines. An example of recursivity is if a ponder routine executes an inference and then mutters the results back to the system using self-talk. This forms the basis for inference chaining. For example:

>>if a man sees the princess then a man loves the princess.
if a man sees the princess then a man loves the princess.
>>if luigi loves the princess then mario is sad.
if luigi loves the princess then mario is sad.
>>luigi sees the princess
luigi sees the princess. luigi loves the princess. sad mario is sad.

### Dreaming

In addition to main loop processing, the system has a facility for finding, indexing, and storing new memories that represent the combined generalized observations of more specific memories. The method for finding generalized memories is called Dreaming.

“Dreams” are a forked copy of the system running during idle times or as a stand-alone program. Given two or more memories that are similar in shape and where the elements of the CCs share concepts with common ancestors, the system may create new memories from their generalizations. Taking “dog chews bones” and “lion chews bones”, for example, the system may create a new memory that abstracts “dog” and “lion” to “animal.” The new memory says “animal chews bones.” At runtime, when “tiger” and “to chew” are encountered, the memory may be resurrected with “tiger” substituted for “animal.”

The generalized memories that are formed from the process of dreaming are subject to occlusion in hash vines searches. By occlusion, the product of dreaming will take a back seat to more specific memories, such as “squirrel chews nuts.” The memories derived from dreaming are not without risk; however, in the absence of a memory about squirrels chewing nuts, the system may assume that squirrels also chew bones. Dream-derived memories are best specified as layer-2 or layer-3 memories, requiring some amount of correspondence with the context as a condition of their restoration.

Given two neighborhoods of memories that are similar in shape and where the elements of the CCs share concepts with common ancestors, the system may derive allegorical conclusions for one neighborhood of memories from the other. For example, in the dog narrative, where the dog is tired, goes into the house, and takes a nap, the user may draw an allegory for when a person is tired and goes into house. Again, this is not without risk. The allegory might suggest someone taking a nap in someone else's house. As with generalizations, derived allegories may have to meet more restrictive restoration criteria than genuine memories.

The value of the restoration of derived memories, such as the product of dreaming, is that they can supplement the context in such a way as to cause the restoration of other sets of memories that are of higher quality. The program recognizes a pattern, restores a derived memory, recognizes a pattern that is the product of the existing context and the derived memory, and then restores a third memory. That third memory may include surprising insights.

### Truth

The algorithmic test for truth within a knowledge representation (KR) environment using data structures that capture knowledge is also provided. A knowledge representation system (KR) may be defined as a system that translates natural language into data structures. The KR system may be a translator and/or a compiler that runs and stops. Independent of their implementations, knowledge representations can be shown to be ontologically isomorphic by virtue of their reproducible translation between natural language and a system's internal representation and back again. By transitive assertion, one can argue that the applicability of this invention applies to all knowledge representations.

| | | | | |
|---|---|---|---|---|
| A | => | B | => | C |
| system 1 | | natural | | system 2 |
| representation | | language | | representation |

If system A's representation is equivalent to natural language B, and system C's representation is also equivalent to natural language B, then system A's representation is equivalent to system C's representation. This implies that whatever claims can be made for system A can also be made for system C. Exceptions, if they exist, lie in the completeness of representations from systems A and C, and the extent to which they capture the context of natural language B. Accordingly, the system proceeds with one example of knowledge representation and extends to the rest.

The depiction in FIG. 10 of how “the dog wants the dog to eat” might appear in a KR system. As stated above, to make a knowledge representation, a system has to recognize the tokens (words) and it has to make sense of their order. Tokens and order are prescribed by a vocabulary and grammar(s). The vocabulary says what the tokens can be. The grammar says how they can be combined. The vocabulary and grammar create the possibilities for, and define the limits of, what the KR system can understand.

As stated above, vocabulary in KR systems are built of taxonomies. Every “concept,” except for the very top concepts, is the child of another. Some are the children of many. A poodle is a dog, a dog is a pet, a pet is an animal, and so on. Concepts for hamster, cat, dog and wildebeest are children (hierarchically) of the concept for animal. See FIG. 2. “Wildebeest” and “pet” are “orthogonal” concepts, as they cannot exist together. A toy is a thing, a ball is a toy. Inheritance is functionally broken when orthogonality is detected. A blue ball is not a red toy, for example, see the CC on the left in FIG. 4a.

As stated above, knowledge representation that is constructed of multiple concepts is defined as a “complex concept” or CC. A CC is a knowledge representation. The edges of the KR are parts-of-speech tagged. Just as individual concepts can be the children of other concepts, whole CCs can be the children of other CCs. For one CC to be the child of another, the child CC must contain the same basic parts of speech as the parent. When the two CCs have the same shape, the two CCs are homeomorphic. Additionally, each of the child's constituent concepts, taken in pairwise comparison to the parent's, must be taxonomic child concepts or be identical.

This invention postulates that truth in a KR systems is subjective, non-boolean, and subject to change. As detailed above, there are a number of situations where a KR may ask itself “is this CC a child of that CC?” or “is this CC true?”. The answer may be unknown, i.e., “is this CC true?” could return MAYBE.

### Algorithm

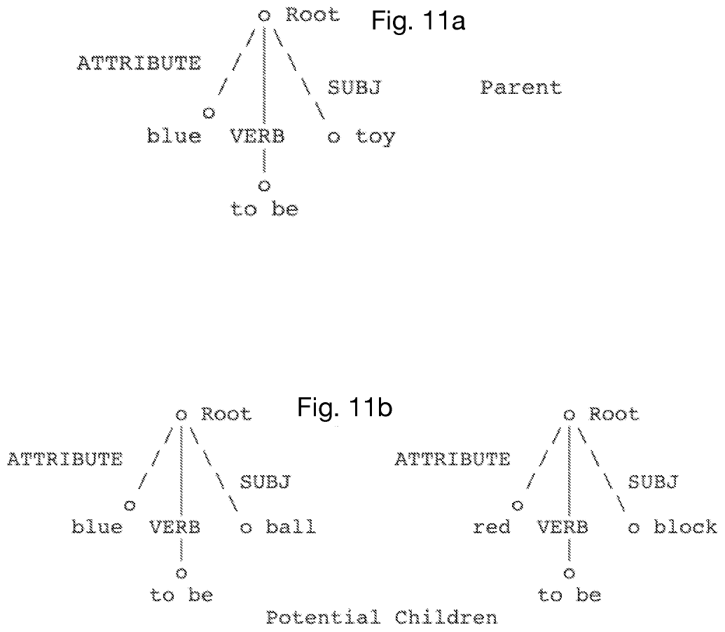

If the KR or KOS system is posed a question, the question itself is cast into a data structure. For example: “is the toy blue?”. See FIG. 11a. Potential answers to the question are located via multi-dimensional hashing mechanism and gathered together. For example, as depicted in FIG. 11b, “the ball is blue” and “the block is red.” The potential answers are tested by a child/parent comparison. To achieve a YES answer, the children must be homeomorphic to the parent (same edges), and the component-wise comparisons must display unidirectional parent/child relationships with no orthogonalities. If a single orthogonality exists, the answer will be NO. If the two are not comparable, or if there are no child candidates, the answer is MAYBE.

### AI Classifier

A supervised-training AI (Artificial Intelligence) classifier in combination with a KR or KOS to produce insight or actions is also provided. An interface and methods for combining a trained, multi-layer perceptron or other artificial intelligence (AI) classifier with the human language-based knowledge representation (KR) system of the present invention to produce a recognition system for knowledge, intention, or events is also provided.

The input to the classifier is human knowledge abstracted as hashes and a vector(s) of tags that correspond to the KR's internal coding. These are applied to the AI. The response from the AI is a scalar, vector, or some other indication that an event of interest has been detected within the KR system. The FIG. 10 schematic is a depiction of how “the dog wants the dog to eat” which may appear in a KR system and be applied to the AI.

Individual vocabulary elements may be each tagged with a numerical index. In combination, elements may assume part of speech roles, such as subject, verb, object, etc. Furthermore, elements in combination may be classified for the type of combination in which they participate. FIG. 5 depicts vocabulary elements and part-of-speech roles combined to create a transitive English proposition, “dog chew bone.” The combination of vocabulary tags, parts of speech, and KR type are defined as a “classification vector.” A natural language corpus, compiled into a KR system, will contain many such classification vectors, ordered temporally or in other kinds of topological neighborhoods such as subject matter, relevance, or keyword.

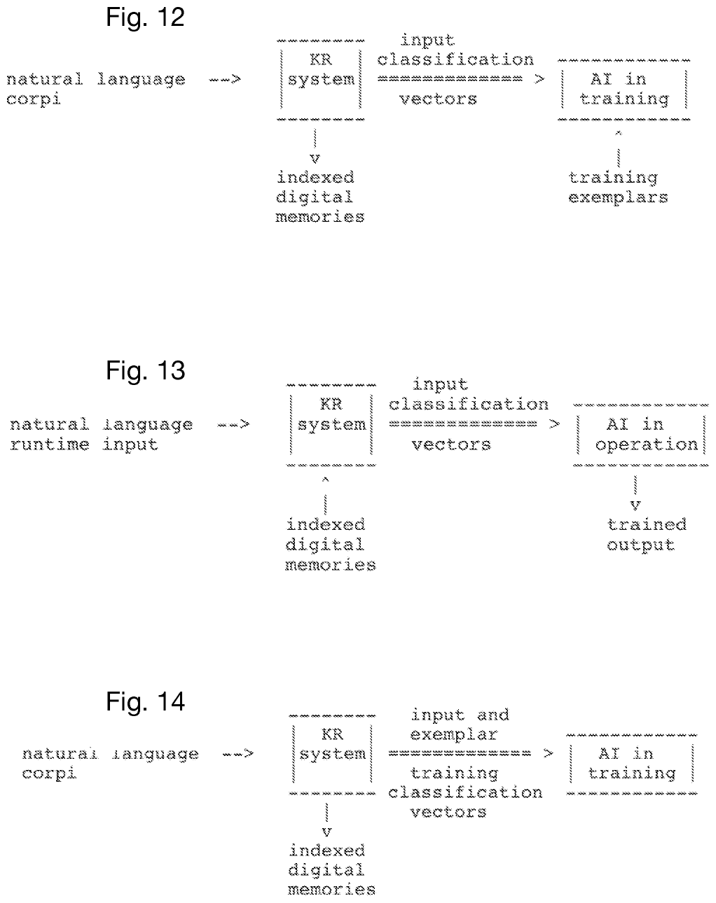

Furthermore, a plurality of corpi compiled in this fashion will produce a plurality of classification vectors, such as the classification vector detailed in FIG. 12. Corpi may be defined as collections of simple English propositions. Classification vectors may be presented to an AI classifier in ordered or unordered multiples for supervised training, i.e. supervised learning. The nature of the training exemplars are determined by the application. They could include an alarm indication, production of a vector representing confidence, event classification, etc. As detailed in FIG. 13. Following supervised training, the classifier may be operated in connection with the KR system. The inputs to the AI are a number of vectors of the same type that were used in training. The outputs will correspond to the training exemplars.

The classification vectors that the KR provides to the AI may be taken from the current context, from inferences, or from other sources. Provided the vocabulary and basic grammars of a given KR system are similar to that of the KR system that was present during training of the AI, the KR can be used with a copy of the same AI. In other words, one trained AI classifier can be used in conjunction with a plurality of KRs employed in many places and for many purposes. In addition, the KR does not need experience with the training corpi or the training set.

As stated above, a natural language corpus, compiled into a KR system, will contain many classification vectors, ordered temporally or in other kinds of topological neighborhoods such as subject, relevance, keyword, etc. Many corpi compiled in this fashion will produce many classification vectors. These vectors may be presented to an AI classifier for unsupervised training, i.e. unsupervised learning. The training exemplars would be classification vectors that come from the neighborhood of the original, potentially representing insight into what-comes-next, additional subject information, etc.

Following unsupervised training, the classifier may be consulted in operation of the KR system to provide insight and implicit inference. The inputs to the AI are a number of vectors of the same type that were used in training. The outputs will correspond to vocabulary tags, parts of speech and KR type, as in FIG. 14, with some caveats, discussed below.

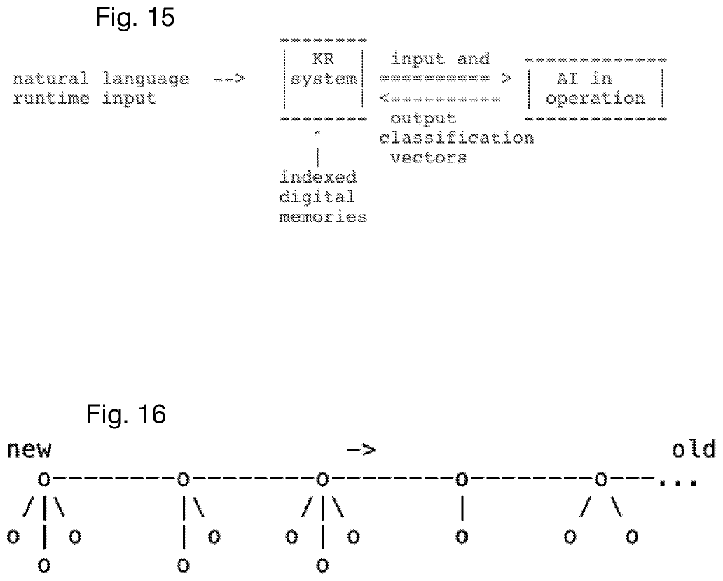

FIG. 15 depicts the AI and KR working in conjunction following unsupervised training of the AI. The KR presents a vector or vectors representing the CCs (natural language representations) in the KR. The AI, having seen these combinations or similar combinations in the past will respond with its own classification vector. The KR will attempt to map this sensibly to the context and derive meaning from the output of the AI.

The results from classification AIs can contain significant error, particularly where the input ranges and domains are well populated. The KR, upon receiving a classification vector from the AI, may employ potentially many techniques to improve the quality of the results, including but not limited to:

Verifying the consistency of the vector's components, with possible error correction substitutions for individual elements;
Testing the classification vector for its ability to invoke hashed data, with possible error correction, the presumption is that if the vector makes sense, there may be digitally stored memories that correspond to it;
Differencing and merging the classification vector results from multiple AIs; and,
Discard of the results.

### Path-Finding, Goals and Problem-Solving

Application of path-finding algorithms to a knowledge representation system (KR) or a knowledge operating system (KOS) in order to implement problem solving is also provided. The unique elements of this embodiment are the operation of memory segments to build forward and reverse paths from an initial condition to an end-state goal. To facilitate path pruning between memory segments, the memory segments provide the paths by identifying conflicts in the paths, paths are also known as orthogonalities. The identified conflicts in the paths are used to deduce a complete description of a path or paths that can then be described in natural language or executed by a knowledge representation system and peripheral components.

The KR that implements the problem solving has the ability to organize narratives into indexed segments, which may also be called memory segments, and to recall the memory segments when conditions similar to those that stored the memory segments are presented. Given, for example, a sequence of statements describing the activities of a dog:

Dog sleeps in the sun.

Dog hears the mailman.

Dog barks.

Dog runs to the door.

Dog scratches the door.

Dog sees the mailman.

Mail falls on the floor.

Dog bites the mail.

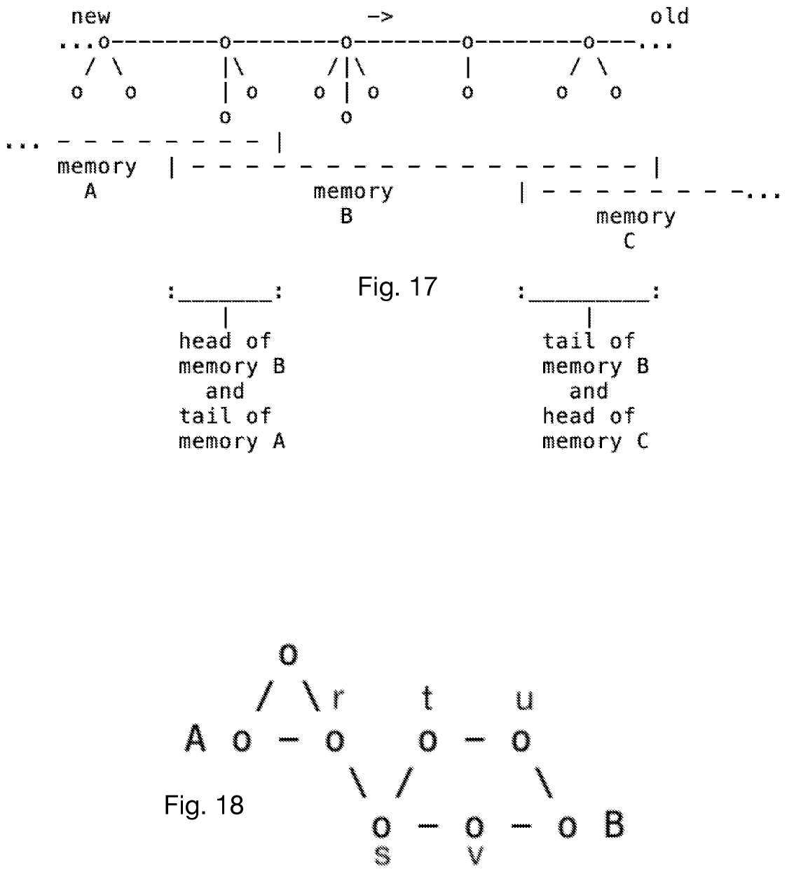

The above language is simple. There is one idea per line. The ideas are in sequence. The KR parses and stores each individual line into an internal knowledge representation data structure, a CC. The CCs become part of an ongoing context, organized from newest to oldest, see FIG. 16. The KR saves linear snippets of the context in an overlapped fashion creating memory segments that may be chronological. Because the memory segments overlap, some portion of each memory segment is also present in the memory segment that precedes it and in the memory segment that follows it. As detailed in FIG. 17, memory segment A, memory segment B, and memory segment C contain CCs that are aligned in linear snippets of the context and overlap.

The memory segments are hashed, indexed, and saved. They form the computational mechanism for storing and recalling stored portions of the context, and for sharing the stored portions with other instances of the KR. It will be typical for many memory segments to be loaded simultaneously. Memory segments are indexed by their contents, i.e by the CCs within each memory segment. The arrangement of the trigger indexes is not important, and the triggers that recall a memory segment may be more general than the contents of the memory segment itself.

The first portion of a memory segment is called the head portion. The head may be indexed separately from the rest of the memory segment. Likewise, the last portion of the memory segment is called the tail portion. The tail may also be indexed separately from the rest of the memory segment. Each memory segment also includes a middle portion between the head portion and the tail portion. As detailed in FIG. 17, the head of memory segment B is the same as the tail of memory segment A and the tail of memory segment B is the same as the head of memory segment C. These memory segments A, B and C, fit together like the tracks of a model railroad set. The memory segments are coupled together overlapping at each end to form one single unit. The overlapping memory segments coupled together are a path to knowledge. The coupled memory segments form memory paths providing a narrative and a plan. If the system poised the question of: How to proceed from starting point A to point C? The memory segment path must go through memory segment B. The system will establish an answer of B; the path from A to C is B. Memory segment indexes predict which pieces will fit with a path and describe where to find them.

Fora non-trivial path-finding exercise, there may be many paths using many memory segments and some memory segments may be reused. Considered as knowledge, the memory segments may be descriptions for how to reach a state or goal given a starting point. Directed graph theory methods are used to find the shortest path within the memory segments. Directed graph theory methods seek to find the shortest distance from one node to another along a series of directed edges. Directed graph theory methods are well known to a person of ordinary skill in the art, are contemplated for use with the present invention, and are within the scope of the present invention. See FIG. 18 for an example of a simple directed graph as might be the subject of the shortest path to discovery. For example, the shortest path from A to B may be found through nodes r, s, t, and u, respectively.

For path-finding in a KR, nodes may be the heads and tails of memory segments. The edges are the portions in between. If there are sufficient indexed memory segments to build a path, any form of an optimal path-finding algorithm might be used to assemble memory segments into a plan for how to reach a goal given a starting point. For example, due to the indexing of the head and the tail of each memory segment it is possible to build a path from “dog is thirsty” to “dog drinks water,” and vice versa.

Dog is thirsty.

. . .

. . .

. . .

Dog drinks water.

When and if a path is found, it can be translated back to natural language and describes the way to get from point A to point C. The natural language path may also describe the steps for an external process to accomplish a task. As there may be many paths and many KRs calculating paths, competition for the best path may be part of the process. In addition, translation to natural language is not always necessary. The discovered path may be applied to an extremal process, a robot, and the like, wherein the path is not expressed in natural language. There are also some instances where the KR or KOS may talk to itself by means of CCs, MCCs, recovered CCs, recovered MCCs, memory segments, and/or the translated natural language in order to create new CCs and new MCCs. The process may be cyclic.

### Application of Orthogonality to Memory Segments

Complex Concepts (CC), also known in this embodiment as the data representing individual statements in KR, may be considered orthogonal to other CCs by virtue of the attributes their differing components carry or because, at a semantic level, they are unlikely to be compatible. For instance a red ball is not a blue ball because ‘red’ and ‘blue’ are orthogonal in the vocabulary, and may not coexist as attributes on a ‘thing.’ Likewise, ‘inside the house’ and ‘outside the house’ are orthogonal because the prepositions ‘inside’ and ‘outside’ are orthogonal and the object of the preposition is the same in both cases. Orthogonality is important in path-finding because it may by chance poison a given path due to orthogonalities along the path.

(Dog is outside the house.)

Dog is thirsty.

. . .

X (path invalid)

. . .

(Dog is inside the house.)

Dog walks to water bowl.

Dog sees water in water bowl.

Dog drinks water.

For example, assume the above path is proposed by an assemblage of memory segments. The subject, ‘dog’, will carry the attribute ‘outside the house’, approaching the path from the top. The subject will carry the attribute ‘inside the house’, approaching the path from the bottom. An orthogonality exists in this path, as shown by X, because the dog cannot be both inside the house and outside the house at the same time. Another, longer path may exist that takes the dog through the door into the house, in which case the dog has a way to satisfy its thirst. This example depicts the attributes as explicit assignments. Attributes may also be inferred.

In addition, forward and backward path-finding are both possible. The KR may ask for guidance if a path cannot be found. The guidance may be for the purpose of resolving an orthogonality or inquiring whether a memory segment index trigger may be true.

Memory processed complex concepts may be sorted through an election process in order to arrive at a single interpretation of the vocabulary elements via output modules. The output modules may be natural language output modules configured to share the output interpretation with at least one endpoint, such as but not limited to, a user, a differing process, and a differing processor. The system also comprises communication modules where results may be stored, retrieved and shared between other KOS of KR instances, processes, and backing stores.

The system may comprise a variety of modules configured to implement the various processes described herein. The modules utilize machine-readable mediums, computer-readable mediums, machine-readable signals, computer programs, and the like. Modules may be defined as any of a number of distinct but interrelated units from which a program may be built up or into which a complex activity may be analyzed. Computer programs may also comprise non-transitory computer executable code embodied in a computer readable medium that, when executing on one or more computing devices, performs the steps of each module individually or in combination.

The system attributes of the present invention or disclosure include, but are not limited to:

Storage and resurrection of memories with potentially incomplete or partial key information and taxonomic references to parents in place of canonical keys;
Combinations of restored memories to create novel insights, cross correlation, concept substitution, and potential further memory restoration;
Creation of generalized memories from groups of similar specific memories;
Use of memory affinity to disambiguate meaning in new input, such as a collection of memories whose partial keys are relevant during a test indicate that one interpretation may be favored over another;
Application of orthogonality tests to potentially conflicting memories to determine which may be a candidate for restoration;
Combination of orthogonality and memory to restore and update specific memories from which to derive expectation, motive, and potential future action; and,
Combination of orthogonality and memory to determine truth.

Various implementations of the systems, modules, methods, and techniques described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described herein. All such permutations and combinations are intended to fall within the scope of the present disclosure/invention.

Computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices.

To provide for interaction with a user, the systems, modules, methods, and techniques described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Input may also be provided by means of a microphone in which verbal input commands are translated into a computer readable form. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input. The systems, modules, methods, and techniques described herein input and output simple human language as computer text. The inputs and outputs may be coupled with speech recognition and text-to-speech for spoken interaction. Input and output interfaces are well known to a person of ordinary skill in the art, are contemplated for use with the present invention, and are within the scope of the present invention.

The systems, modules, methods, and techniques described herein may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems, modules, methods, and techniques described herein), or any combination of such back end, middleware, or front end components. The components of the system may be interconnected by any form or medium of digital data communication (e.g., a communication network). Examples of communication networks include a local area network (“LAN”), a wide area network (“WAN”), wifi, and the Internet.

The computing system may include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the invention. It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims. The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. Absent an explicit indication to the contrary, the disclosed steps may be modified, supplemented, omitted, and/or re-ordered without departing from the scope of this disclosure.

Any information in any material (e.g., a United States patent, United States patent application, book, article, etc.) cited herein are incorporated herein by reference in the entireties, except for any definitions, subject matter disclaimers or disavowals, and except to the extent that the incorporated material is inconsistent with the express disclosure herein, in which case the language in this disclosure controls.

What is claimed is:

1. A knowledge operating system (KOS) programmed in human language comprising:
a token recognition module configured to collect a plurality of vocabulary elements and combine the vocabulary elements into a plurality of data structures;
a plurality of explicit and implicit inference modules configured to process the data structures into a plurality of knowledge based complex concepts (CCs);
a memory module (MM) configured to read, collect, store, index, group, and transform CCs into a plurality of memory processed complex concepts (MCCs);
a plurality of communication modules configured to store, retrieve, and share results obtained from the MCCs between one or more additional systems programmed in human language, processes, and backing stores;
a plurality of output modules configured to sort MCCs through an election process in order to arrive at a single interpretation of the vocabulary elements; and,
one or more natural language output modules configured to share the single interpretation with at least one endpoint.

2. The knowledge operating system of claim 1, wherein the vocabulary elements are hierarchical and derived from regular language input selected from the group consisting of voice command, typed, and electronic.

3. The knowledge operating system of claim 1, wherein CCs and MCCs are stored as one or more triggers organized and accessed with one or more hash vines.

4. The knowledge operating system of claim 3, wherein the presence of one or more triggers initiates the system to restore one or more selected from the group consisting of CCs and MCCs.

5. The knowledge operating system of claim 4, wherein the restored CCs and restored MCCs combine with CCs and MCCs to arrive at the single interpretation of the vocabulary elements.

6. The knowledge operating system of claim 5, wherein simultaneously,
(a) one or more restored CCs and one or more restored MCCs are stripped and removed from the MM when relevance is lost; and,
(b) one or more restored CCs and one or more restored MCCs are rebuilt in to one or more new CCs and one or more new MCCs.

7. The knowledge operating system of claim 4, further comprising a plurality of motives configured to permanently direct processing toward one or more specific goals.

8. The knowledge operating system of claim 7, wherein the motives operate in conjunction with multiple concepts comprising one or more CCs, one or more MCCs, one or more restored CCs, and one or more restored MCCs.

9. The knowledge operating system of claim 8, wherein during the election process the multiple concepts are processed to determine orthogonality.

10. The knowledge operating system of claim 9, wherein orthogonality differentiates between objects and attributes within the multiple concepts by semantic evaluation.

11. The knowledge operating system of claim 9, wherein the motives take precedence over conflicts in orthogonality.

12. The knowledge operating system of claim 4, wherein multiple concepts levels comprise one or more multi-level CCs, one or more multi-level MCCs, one or more multi-level restored CCs, and one or more multi-level restored MCCs, and the system is further configured to:
(a) recognize a pattern amongst a first level of one or more multiple concepts levels;
(b) restore the first level of the one or more multiple concepts levels;
(c) associate the restored first level with a pattern that is a product of a second level of the one or more multiple concepts levels; and,
(d) create a differing third level of the one or more multiple concepts levels.

13. A method comprising the steps of:
(a) communicating with an artificial intelligence (AI) through presentation of one or more classification vectors from the knowledge operating system (KOS) of claim 1;
(b) interpreting the one or more classification vectors as new input data or old input data by means of the AI;
(c) creating a new classification vector based on the interpretation in step (b);
(d) returning the new classification vector to the KOS;
(e) sorting the new classification vector through an election process in order to arrive at a single interpretation of the one or more classification vectors.

14. The method of claim 13, wherein step (b) further comprises the steps of:
(b1) verifying an orthogonality of one or more classification vectors components;
(b2) correcting for error substitutions within the individual components of step (b1);
(b3) testing the components of steps (b1) and/or step (b2) for an invocation of hashed data;
(b4) correcting for error substitutions within the individual components of step (b3); and,
(b5) determining the one or more classification vectors components as the new input data or the old input data.

15. The method of claim 14, wherein the one ore more classification vectors components include one or more vocabulary tags, one or more parts of speech, one or more CCs, MCCs, restored CCs, and restored MCCs, or one or more inferences; and, the classification vectors components are ordered temporally by subject matter, relevance, or keyword.

16. The method of claim 13, wherein the one or more classification vectors are produced by a plurality of corpi compiled in the KOS.

17. The method of claim 13, further comprising the steps of:
(f) differencing and merging the new classification vector with multiple AIs; and,
(g) discarding the results from step (c).

18. The method of claim 13, wherein AI training is selected from the group consisting of supervised and unsupervised.

19. A method of problem solving by means of a knowledge representation system (KR), the method comprises the steps of:
(a) establishing an index of memories within the KR;
(b) building forward memory paths and reverse memory paths by means of a plurality of memory segments;
(c) indexing and storing the memory segments;
(d) inputting an initial condition starting point;
(e) identifying the stored memory segments of step (c) that contain conditions similar to the step (d) starting point; and,
(f) outputting at least one final condition end point by means of one or more output modules.

20. The method of claim 19, wherein the step (a) memories are complex concepts (CCs) and the CCs are stored as one or more triggers organized and accessed with one or more hash vines.

21. The method of claim 20, wherein the step (b) memory segments comprise a plurality of the step (a) CCs connected in a chronological linear path and each memory segment comprises a first portion head, a middle portion, and a last portion tail.

22. The method of claim 21, wherein the plurality of memory segments are coupled together and the head portion and the tail portion of each memory segment overlap.

23. The method of claim 21, wherein in step (c) each of the head portion and each of the tail portion of each memory segment may be indexed together or separately.

24. The method of claim 19, wherein identifying in step (e) comprises finding the shortest memory path from the starting point by means of directed graph theory.

25. The method of claim 19, wherein step (e) further comprises identifying conflicts in the memory path to determine orthogonality.

26. The method of claim 25, wherein orthogonality differentiates between objects and attributes within the CCs, memory segments, and memory paths by semantic evaluation.

27. The method of claim 19, wherein step (e) further comprises identifying the shortest memory path by both forward path finding and backward path finding.

28. A method of problem solving by means of a human language-based knowledge representation system (KR) the method comprises the steps of:
(a) establishing an index of memories within the KR;
(b) building forward memory paths and reverse memory paths by means of a plurality of memory segments;
(c) indexing and storing the memory segments;
(d) inputting an initial condition starting point;
(e) identifying the stored memory segments of step (c) that contain conditions similar to the step (d) starting point;
(f) translating the identified stored memory segments of step (e) into natural language;
(g) generating the natural language of step (f) into a final condition end point; and,
(h) outputting the final condition end point by means of one or more natural language output modules.
